(19) United States
(12) Patent Application Publication
(10) Pub. No.: US 2013/0282580 A1
(43) Pub. Date: Oct. 24, 2013

(54) SYSTEMS AND METHODS FOR EXTENDING IDENTITY ATTRIBUTES AND AUTHENTICATION FACTORS IN AN ePAYMENT ADDRESS REGISTRY

(71) Applicant: Payment Pathways, Inc., Chicago, IL (US)

(72) Inventors: Richard J. O'Brien, Lisle, IL (US); Andrew Gallant, Rockville, MD (US)

(21) Appl. No.: 13/838,187

(22) Filed: Mar. 15, 2013

Related U.S. Application Data
(63) Continuation-in-part of application No. 12/892,187, filed on Sep. 28, 2010, now Pat. No. 8,447,630.
Application No. 12/892,187 is a continuation-in-part of application No. 11/592,510, filed on Nov. 3, 2006, now Pat. No. 7,945,511.
Application No. 11/592,510 is a continuation-in-part of application No. 10/786,023, filed on Feb. 26, 2004, now Pat. No. 7,831,490.
(60) Provisional application No. 60/733,982, filed on Nov. 3, 2005.
(60) Provisional application No. 60/450,754, filed on Feb. 28, 2003.

(51) Int. Cl. G06Q 20/40

(52) U.S. Cl. CPC G06Q 20/4014; G06Q 50/265
USPC 705/44

(57) ABSTRACT

The present invention relates to a network of registries that are: synchronized in whole or in part to a root registry; and are compilations of registrant data from accredited Identity Providers that accept liability for registering verified and accurate identity attributes. Registries associate a unique identifier with: a financial account owner's Personally Identifying Information; one or more linked publicly discoverable ePayment addresses to an account at a Financial Institution; and a financial account owner's profile of preferences related to the capture, handling, transfer and storage of monetary and informational assets. Preferences extensions include: operating instructions and rule sets; and authentication factors that may make use of time sensitive data at one or more institutions.

### CROSS REFERENCE TO RELATED APPLICATIONS

This application is a continuation-in-part of U.S. application Ser. No. 12/892,187 filed Sep. 28, 2010, published as U.S. Patent Publication No. 2011-0016536, which is a continuation-in-part of U.S. application Ser. No. 11/592,510 filed Nov. 3, 2006, now U.S. Pat. No. 7,945,511. U.S. application Ser. No. 11/592,510 is a continuation-in-part of U.S. application Ser. No. 10/786,023 filed Feb. 26, 2004, now U.S. Pat. No. 7,831,490, and claims priority to U.S. Provisional Application No. 60/733,982 filed Nov. 3, 2005. U.S. application Ser. No. 10/786,023 claims priority to U.S. Provisional Application No. 60/450,754, filed Feb. 28, 2003. The entire contents of those applications are incorporated herein by reference.

### FIELD OF INVENTION

This invention relates to a computer system and method to a.) establish and validate an individual's new and existing unique identity attributes related to the individual's primary identity; b.) validate physical devices when used to effect the transfer, storage and retrieval of informational and/or monetary assets; c.) maintain safeguards to ensure that custodians of informational and monetary assets execute instructions of owners; and d.) facilitate the use of additional authentication factors when effecting the transfer, storage and retrieval of informational and/or monetary assets.

### BACKGROUND

In the face of mounting market shifts, new technologies, and regulations, financial institutions must look to new revenue sources. The growth in e-commerce, mobile commerce, and alternative providers adds urgency to that search.

Greenlist® verified ePayments are safe and secure without consumers having to disclose any actual account or bankcard information whatsoever. In order to attain scale and ubiquity, this registry resource is operated by a network of synchronized Authoritative Parties that verify identities and payment addresses before transactions are made. Data in the Greenlist® network of registries are supplied by only Financial Institutions (FIs) functioning as registrars that accept the liability for accuracy. Registrars perform identity proofing of every registrant's Personal Identifying Information (PII) prior to registering new linked identity attributes to the Greenlist® registry. A Relying Party obtains access to trusted registrant data from an Authoritative Party and may provide access for applications or individuals via its public or private portal.

FIs maintain the Greenlist by becoming accredited and therefore trusted Identity Providers who assume the risk for identity-related fraud based on the customer information they place in the registry. This approach substantially reduces the Relying Party's cost of bearing risks because they are left with only those risks associated with payer authentication and authorization—risks entirely in their own control.

Regulations such as Dodd-Frank Section 1073 require new levels of transparency and identity proofing for cross-border payment transactions. The Federal Financial Institutions Examination Council (FFIEC) further advises Financial Institutions to layer additional authentication security factors as risk increases. These regulatory pressures mirror congressional intent and are executed under the authority of the Central Bank of the U.S., namely, the Federal Reserve Banks Sovereign states want their regulatory regime to a.) support Anti-Money Laundering best practices, b.) be aligned with the U.S and c.) operate accordingly in harmony with the U.S.

Because of the effect of new regulations banks are now beginning to recognize their need for new methods and systems with speedy access to information pertaining to which currencies a recipient can or will accept and which foreign exchange companies are approved for use by the issuer of the recipient's financial account. Supplying this information in the most expeditious manner possible is valuable because it further enables payments across borders to be made instantly and because of the trust in the recipient's address, payments across borders can also be made without repudiation due to lack of sender authorization.

A system to determine a priori that identity attributes and authentication factors must be used and how to obtain them is the subject of this invention.

### EMBODIMENTS OF THE PRESENT INVENTION

This invention relates to a computer system and method to extend an ePayment address registry to a.) establish and validate an individual's new and unique identity attributes related to the individual's primary identity; b.) validate physical devices when used to effect the transfer, storage and retrieval of informational and/or monetary assets; c.) maintain safeguards to ensure that custodians of informational and monetary assets execute instructions of owners; and d.) facilitate the use of additional authentication factors when effecting the transfer, storage and retrieval of informational and/or monetary assets.

The ePayment address registry as disclosed in previous inventions a.) links PII public ePayment addresses to enable the immediate transfer of funds; b) enables the immediate transfer of informational assets; and c.) references instructions based on privacy preferences permitting capture, storage and disposition of certain informational assets. The intent of the aforementioned inventions was to make ePayments safe and secure without consumers having to disclose any actual account or bankcard information whatsoever.

This invention extends the ePayment address registry to include identity attributes and authentication factors. This invention then extends the scope and usage of identity attributes and authentication factors to a broader range of informational and/or monetary asset transfer transactions.

The invention described herein extends the application of Greenlist ID by adding to its set of associated identity attributes and by creating a secondary Greenlist ID for some attributes that are necessary for certain other classes of machine-to-machine use cases.

For example, the case of merchant-initiated “pulls” of money commonly requires an automatic second factor that the party authorizing the “pull” is authentic. This use case utilizes a method and system of identifying and validating hardware device(s) that are certified for use to communicate the transaction authorization. Having validation of the three primary authentication factors—something you know; something you have; and something you are—minimizes multiple operational risks.

The use of additional authentication factors applies to a wide range of transaction types with common purposes that include the reduction of risk of fraud, costs and time to process.

This invention helps merchants by reducing systemic chargebacks associated with payments that are repudiated due to lack of proper authorization. Merchants offset their costs of interchange by reducing or eliminating their interchange fees altogether by selling valuable marketing behavioral data and analytics that are otherwise unobtainable by supply chain product and/or service suppliers. Merchants that elect to provide data for analyses of their customers' behavior will have trade advantages in the marketplace because they and their suppliers will have new awareness and capability to communicate with various customer base segments.

Payments data is now more valuable than ever before for behavioral targeting. Online advertising/data analytic companies realize premium value for data related to payments, especially data from consumers when they transact while mobile. Online advertising/data analytic companies realize opportunities for mashups by consolidating reporting and giving advertisers the ability to compare data directly as opposed to trying to process it all themselves.

For example: a customer who orders food online becomes part of a vast database that lenders might tap to help them determine whether you are a good risk. A food delivery proves that a customer actually resides at an address where the customer claims to be living. Moreover, all sorts of these data reservoirs exist, and none of them is off limits to lenders, who are coming off the worst financial debacle since the Great Depression. Risk management companies work with lenders and investors to build better underwriting mousetraps by continuously probing for ways to help clients quantify their risk to prevent fraud and otherwise insure the quality of their loans.

For example, a risk management company might peek into a customer's online-buying habits. Someone who purchases shirts from a Brooks Brothers catalog may have more disposable income than someone who shops at J.C. Penney. The safest lenders are digging into databases maintained by Domino's Pizza, Papa John's or Victoria's Secret. The only boundary is whether the information can be accessed legally. Mobile payments initiated from a smartphone can replace cash, checks and even bankcards for smaller transactions. Personal identifying information such as caller ID number and other identifiers may be used to authenticate the owner of the smartphone in order to mitigate risk that a payment is authorized. Trust that sales data obtained from authentic sources can be proven and legally certifiable will be valuable when dispute of information ownership may arise.

Accordingly, various embodiments of the present invention address these and other situations and issues through the existence and use of extensions to the ePayments address registry.

In one embodiment, a merchant acting as a Relying Party will query the ePayment address registry to retrieve one or more additional authentication factors for a customer engaged in a purchase transaction and/or other type of transaction. Such factors are stored in the registry when a customer (registrant) is enrolled, i.e., registered by a trusted registrar, or when a registrar or proxy registrar adds or updates the registration of an existing registrant. During the transaction, the customer supplies an identifier and public payment address. While setting up the transaction, the merchant chooses to seek additional authentication, and in one approach, the merchant will compare one or more additional authentication factors supplied by the customer with the same factors as retrieved from the registry, which is a trusted source. When these factors match, the merchant has the additional assurance that the customer is indeed authentic, and the transaction proceeds.

In another embodiment, a customer may choose to add an identity attribute related to payment and/or currency conversion instructions. Such instructions may exist in the ePayments address registry, may be stored elsewhere, or may be provided or customized during a payments or currency conversion transaction. For example, when a payments transaction involves conversion between currencies, the payment instructions may indicate the degree to which a customer receiving a payment in another currency chooses between the speed of the currency conversion and the conversion rate to be applied, e.g., whether the customer chooses between an instant payment at one rate or a delayed payment at a presumably lower rate. In this embodiment, the bank serving the customer who will receive a payment (the payee) will query the ePayments address registry for one or more identity attributes related to payments and currency conversion. While setting up the payment transaction with the payor's bank, the payee's bank will determine the applicable instructions and communicate them to the payor's bank. The payor's bank will then process the payment in accordance with those instructions.

In another embodiment, a customer (registrant) may wish to have an assured yet anonymous business arrangement, such as a paid subscription, with a merchant, content provider, or service provider, subject to applicable and appropriate laws, terms, and conditions. In this embodiment, additional identity attributes are created and stored in the ePayments address registry. Such attributes may include but are not limited to a customer identifier, possibly anonymized and/or hashed, trusted assertions about the customer, such as age or nationality, and payment information, which may include an additional ePayment address, possibly tokenized. In one example, the customer wishes to make an assured yet anonymous purchase from a merchant, in order to protect the customer's privacy. First, the customer provides an identifier and payment address. The merchant then queries the registry to validate this information. Next, the merchant may also require additional data, such as proof of age of the customer, or the customer's nationality. Then, the merchant may query the registry to receive said additional data, and may also query the registry for additional authentication factors. In this embodiment, sufficient assurance is presented to allow the merchant to fulfill the purchase, knowing both that the payment is assured and that the customer is valid; in addition, the customer is able to make the purchase yet preserve privacy and anonymity; and, both parties are assured that applicable laws, terms, and conditions have been followed.

In another embodiment, a customer's mobile or other device can be provided with one or more additional authentication factors. For example, an authentication factor for a customer can be stored both a.) either directly in the ePayments address registry or indirectly via a source pointed to from the registry, and b.) in the Secure Element of that customer's mobile device. When, for example, that device is used to make a purchase or to redeem, display, present or transfer a plane or theater ticket, the merchant can use that additional factor to validate the use of the device for the intended purpose. To do such a validation, the merchant may compare the factor retrieved from the mobile device with the relevant information provided either directly from the registry or indirectly from a source pointed to from the registry. This validation provides additional assurance that the user of the mobile device is indeed the intended customer and that the mobile device is authorized for such usage. This can be optionally be used in conjunction with or instead of a shared secret or “something known” to attain the threshold risk score that is required for the transaction to proceed. Note that communications involving one or more of bar and/or QR codes, NFC, OTA (over the air), IR, email, SMS or WiFi may be used during the above redeem, display, present and/or transfer actions above.

In another embodiment, a customer's registration records may include identity attributes related to other information or transaction addresses. In one example, a registrant may wish to include a Bitcoin address, so that this address may be retrieved during a transaction when both parties agree to use Bitcoins as the currency. In this case, the payee (the customer) provides at least the identifier registered in the ePayments address registry. The payor, who may be either trusted or may be acting through a trusted entity, receives the payee's Bitcoin payment address after the registry is queried, and may then proceed with the transfer. In other examples, other payment addresses, e.g., for bank accounts, PayPal™ accounts, etc., may be stored as identity attributes, possibly masked, hashed, or tokenized, and then retrieved for use.

In another embodiment, a customer's registration records may include other identity attributes for use in payment or information transactions. In one example, a customer's digital signature may be stored as an attribute. In another example, a pointer to a customer's digital certificate may be stored as an attribute. In this case, an entity that queries the ePayments address registry will be able to retrieve the customer's public key, which can then be, among other things, applied to materials encrypted or signed by the customer, or for encrypting materials to be used by the consumer.

In another embodiment, the payor-to-payee transaction may be subject to certain compliance requirements. In one example, the transaction will not be compliant unless certain PII-related information concerning the payor is provided to the payee during the course of the transaction. This requirement can be satisfied through the use of the ePayments address registry. First, the payor's profile is updated by a trusted registrar or proxy to contain the required information. The profile may also contain an indicator of compliance, such as of certification by a trusted third party or of a self-certification, and the profile may contain pointers to further sources of such information that may be stored external to the registry. In this example, the payor's PII-related information and possible indicator of compliance may be considered both as identity attributes (as information related to the payor) and as authentication factors (as information required by the payee), since the payee is the Relying Party.

In another embodiment, the information transaction may include the transfer or delegation of authority for one registrant to act on another registrant's behalf. For example, assume that a valid Power of Attorney is in effect, and that it grants the right for Registrant B to act on Registrant A's behalf in matters using the ePayments address registry. In this case,

Registrant B could, for example, as an authorized agent of Registrant A, engage in a purchase transaction during which Registrant B can use Registrant A's payment address. To do so, each registrant's profiles would, via their respective registrars, include identity attributes that record the authorization. Further, authentication factors would be used between said registrars to ensure that Registrant A had granted sufficient authority to Registrant B to effect the latter's agency.

Device specific information, account specific information, biometric specific information and challenge specific information can be considered to be identity attributes. For example, the information included may range from specific data values (such as an individual's age) to ranges or classes of data or to summary information about this data (such as an individual being at least 21 years of age). For this invention, such attributes may include not only data but may also include indicators (e.g., flags) or pointers (e.g., addresses or links) related to data traditionally thought of as attributes. Below is a partial list of identity attributes included in the extended ePayments address registry in this invention.

Extended Types of Identity Attributes (stored, pointed to, or indicated by the registry):
PII (Personally Identifiable Information)
Demographic Information (e.g., age or age bracket)
Transaction Profile Information (e.g., additional payment address(es), payment and/or currency conversion instructions)
Other data and metadata related to the registrant's identity (e.g., additional identifier, additional profile information, pointer to digital credentials, rules)

Here, rules included as identity attributes may refer operationally to a business rules database or a transaction rules database that can follow a pre-determined path as defined by the consumer, the network, or the merchant so that, based on various operational conditions, the usage of the database can follow differing logical paths.

Also, roughly speaking, for the purposes of this invention, authentication factors may be considered to be data used to verify an individual's identity typically during the course of effecting the transfer, storage and retrieval of informational and/or monetary assets. In particular, such data may include the existence of operating instructions related to effecting such a transaction, Further, such authentication factors may be included directly in the extended ePayments address registry in this invention, may be signaled by indicators, or may be referenced indirectly. Below is a partial list of such authentication factors.

Extended Types of Authentication Factors (stored, pointed to, or indicated by the registry):
Specific information known by an individual
Biometric information for an individual
Digital credential or token of an individual
Device-specific or chip information (such as unique device or other identifiers, account information, IMEI, SIM data)
Operating instructions relevant to a transfer, storage, and/or retrieval transaction

### BRIEF DESCRIPTION OF THE FIGURES

FIG. 1 depicts a flow diagram of the method of facilitating a cross border asset transfer transaction using extensions for preferences for payment instructions incorporated in the present invention.

FIG. 2 depicts a flow diagram of the method of additional verification of a customer using extensions for authentication factors incorporated in the present invention.

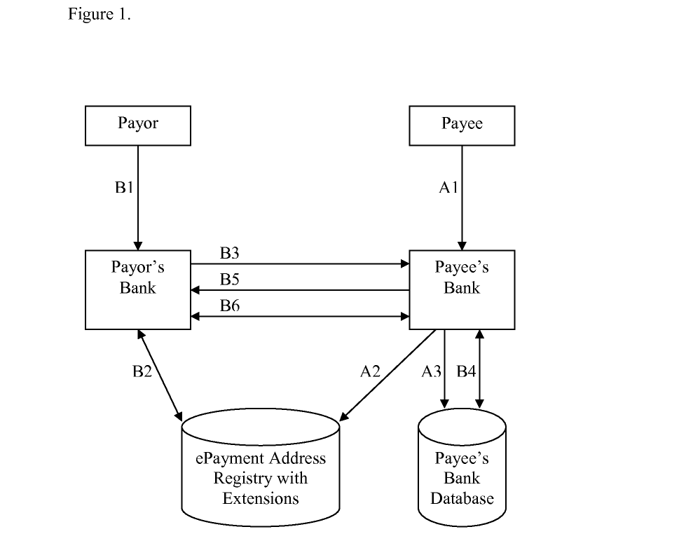

In FIG. 1, a payor intends to effect a payment transfer to a payee. The transaction involves currency conversion and notification to the payor of the amount of funds to be paid out upon receipt, net of all fees, in the payee's currency of choice. Prior to the transaction, the payee has entered payment preferences A1 (e.g., that an instant payment at the current currency conversion rate of a specified foreign exchange index is mandatory or that a payment within 12 hours at a currency conversion rate that is most favorable among all possible foreign exchange services available to the payee's bank) into the payee's bank. The payee's bank enters a flag A2 into the extended ePayments address registry that indicates the existence of payment instruction preferences for the payee, and the payee's bank has stored said instructions A3 in its own database. When the payor initiates the payment transaction B1 via the payor's bank, said bank queries the registry B2 for payment information regarding the payee. Upon discovering that payment instruction preferences exist for the payee, the payor's bank queries the payee's bank B3. The payee's bank retrieves and executes the payee's payment instruction preferences B4 from its database. The payor's bank receives the payee's payment instruction preferences B5 from the payee's bank. The payor's bank calculates the net sum to be paid out, notifies the payor, obtains final payment authorization and then initiates and effects the transaction B6 with the payee's bank subject to said payment instruction preferences.

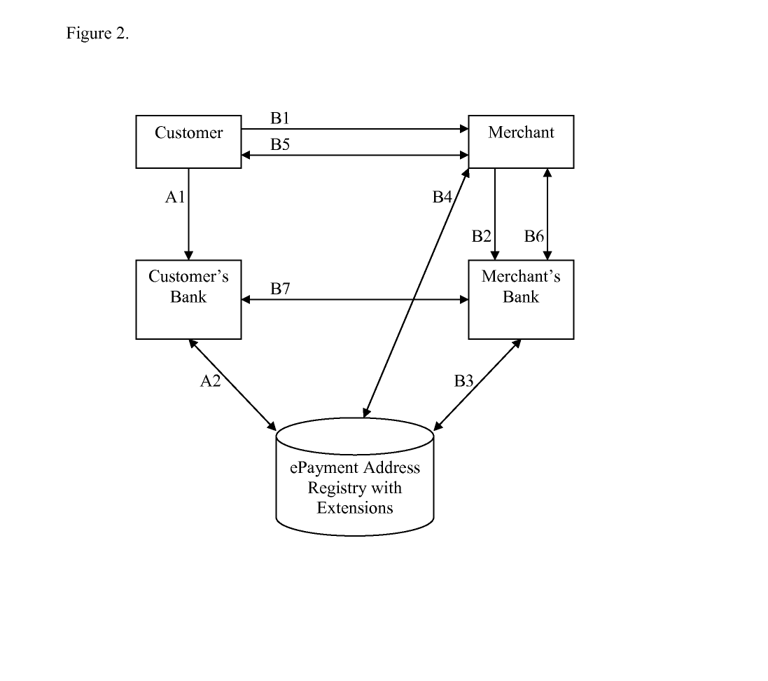

In FIG. 2, a merchant's bank initiates a request for a non-revocable payment from a payor's bank by taking steps to mitigate certain risks of payor repudiation on the grounds that the payment was not authorized by considering additional authentication factors to validate both the customer (i.e., payor) and the customer's device used to make a purchasing transaction. Prior to the purchase, the customer's bank has acquired additional authentication factors A1 from the customer, and in this example the customer's bank has stored those authentication factors A2 in the extended ePayments address registry. When the customer initiates a purchase B1 from a merchant, the merchant's bank initiates a transaction B2 with the payor's bank. The merchant, as a Relying Party, retrieves verification that the Payee's Personal Account Number is registered and authorized for use if and only if additional authentication factors B3 related to the customer from the extended ePayments address registry are retrieved and used to authenticate the payor. The registry communicates authentication instructions B4 with the merchant, and the merchant conducts authentication activity B5 with the customer, so that authentication factors provided by the customer (and/or the customer's device) may be verified with respect to the previously stored authentication factors. Upon successful completion of the authentication steps of the customer and the customer's device used, the merchant's bank submits notification to the payor's bank (or its proxy) that the authentication steps have been completed, and then continues to complete the purchase transaction B6 with the payor's bank. Finally, the payor's bank validates that the authentication instructions were met and effects the payment transaction B7 with the customer's bank.

The present invention relates to extending previously established use cases for a network of registries of unique identifiers linked to payment addresses and containing information asset repository addresses, privacy and notification preferences, and other data.

In a preferred embodiment of the present invention, a central directory and/or processor (registry) is established and made available to entities wishing to certify the authenticity of instructions to risk bearing institutions and the conditions for when to apply said instructions. The application of said instructions governs various decisions that affect the transfer of monetary and informational assets. The registry marks these instructions as mandatory or optional as deemed by the registrant. The Relying Party that submits queries may be instructed to be redirected to applications residing on other systems whereby the resultant responses deliver certain forms of user authentication data and/or digital credentials or tokens. According to another embodiment, certain Publicly Identifying Information and/or other information attributes can become released only after a Law Enforcement or other legally authorized entity obtains full PII disclosure after legal review by a judge and the issue of subpoena.

In a preferred embodiment, this invention facilitates certain transactions such as Cross-border Remittances and Asset Transfer Applications via the use of certain identity attributes and authentication factors, and such information and/or pointers to such information may be stored in the ePayments address registry. Such identity attributes and authentication factors may include but are not limited to the following:
Identity Attributes
   Sender-Receiver Linkage information
   Foreign Exchange Instruction
      Currency Preference (Mandatory/Optional)
      Least Cost Routing
      Hedge
      Timing Preference (Instant/Non-instant)
Authentication Factors
   Secure Element Discovery redirection
      Unique Device Identification (IMEI, Mac Address, UICC, EIN, Secure Element, PKI key, Private Key, Encryption key, token, chip identifier)
      On Screen Display (identifiers, graphics, bar codes, QR codes)
      Communications Methods (Over The Air (OTA) messaging, Cloud Credentials, WiFi, IR, NFC or other wireless methods)
      Cryptographic Elements (Hash, Encryption, Algorithmic, and other Cryptographic techniques)
   Transaction Match

It should be noted that various elements in the above list of authentication factors will apply in other embodiments of the invention, and thus in a range of other use cases.

Cross-border Individual Payer Remittance Payments

Increasingly, regulators require sending institutions to acquire and report such identity attributes to verify that the identities of both parties to a transaction are known prior to moving money across borders. These attributes may include the recipient's name, address, and the account number and financial institution where the money is to be deposited. Generally, eighty-five percent of the cross-border transfers are repetitive transactions between the same two individuals. This linkage is in effect an identity attribute of a sender who habitually sends money to the same receiver and it is also an identity attribute of a receiver who habitually receives money from the same sender. Risk bearing institutions are the entities that initiate the money transfer process. This may occur in two classic ways. First is the case when a receiver's bank “pulls” a debit of a sender's account. For this case, querying a registry to see if the sender's unique identifier is linked to the receiver's unique identifier informs risk scoring and mitigates the risk that a card number might be stolen and used without authorization. In the second case, where a sender's bank “pushes” a credit to a receiver's account, querying a registry to see if the receiver's unique identifier is linked to the sender's unique identifier informs risk scoring and it mitigates the risk that an imposter might be posing as a legitimate accountholder seeking to supply payment instructions that are outside the boundary of normal payment authorization.

Transactions with Intermediate Currencies

One practical use of Bitcoin addressing now is the emerging practice of performing currency exchanges when Bitcoin is used as the intermediate currency in a two-step transaction.

In cases where an anonymous Bitcoin ePayment address is registered in the Greenlist, Anti-Money Laundering (AML) concerns are alleviated because lawful interceptors now have a mechanism to subpoena records of the Identity Provider that functioned as the registrar of the Bitcoin ePayment address. In the future, the banks with customer accounts that are the final recipient account addresses of a multi-step money transfer, and where that transfer involves intermediate currency conversions, can be regulated to only receive money transfers from a intermediate Bitcoin currency account that is registered as paired with a sender's unique identifier, and additionally when that sender's identity is similarly registered as linked to the receiver. In this example, anonymity can be protected for commercial and privacy purposes but in extreme cases where threats to the state or public safety are concerns, a mechanism can exist for lifting the veil of anonymity after proper judicial review and permission is obtained.

Cross-border Business Payer Remittance Payments

Transactions across borders between businesses in a supply chain may be regular and repetitious, and they may be confined to a few transacting parties; alternatively, transactions may by irregularly timed and the amount of funds in any single transfer may vary widely. Senders may transact with numerous receivers and receivers may transact with multiple senders. When currency conversion is part of the task, the financial institution in the country where funds deposit may: a.) determine the method by which currency value is exchanged or b.) have the payment network or other third party institution perform the currency exchange as a service. As the sums of money transferred and/or the frequency of transfers increase, there is an increased incentive on the part of the recipient to take steps to guarantee that the values of deposits are maximized. It is an attribute of a recipient's identity to require that steps are taken that maximize the value of funds depositing in a recipient's account. This attribute is in the form of a ‘flag’ that when in the on position, requires that the risk-bearing institution that is tasked by the sender to effect a remittance payment should de-couple the foreign exchange function from the money transfer and settlement functions. This information is conveyed during a normal lookup to capture and/or verify a recipient's identifiers to achieve regulatory compliance. In order to comply with the recipient's rules, the sender's Financial Institution must query multiple foreign exchange bid/ask quotations and select the service having the most beneficial rates from the recipient's perspective prior to executing a transaction for currency exchange.

Transactions with Age Verification Requirements

Individuals may wish to purchase an NC-17 theater ticket, a gun, a bottle of wine, adult content, or simply apply a senior citizen discount to purchased items. Verifying that the age of the transacting party is at a minimum 18, 21, 65 or some other age is an identity attribute that is tangential to a payment transaction but still important from pricing and compliance standpoints.

Transactions with Sender and/or Receiver Identification Requirements

The aforementioned gun purchase may require additional identity attributes in addition to verifying that the age of the transaction participant falls within an acceptable range. The aforementioned wine purchase may be subject to a geographic requirement that a gift or purchase not be delivered to a location prohibited by state or local law. Attributes such as health-check, police records-check, etc. may be acquirable by the seller, but such attributes might not be directly available without the transacting party's opportunity to give explicit permission to various identity attribute repositories, identity attribute exchanges, or identity attribute providers. The registry (Greenlist) may include identity attribute referral flags for any number of identity attribute checks including TSA applications, Government discounts, access, etc.

Many more circumstances can be envisioned wherein identification requirements may be involved. For automobiles, VINs, license plate numbers, or E-ZPass® transponder numbers may be required for transactions involving fuel or tolls. For charitable contributions or political donations, certain PII may be record-keeping requirements for such transactions. For example, to comply with possible future FCC regulations, paid political advertising may require the individual identification of the major contributors behind the messages that consume airtime.

Transactions with Mobile Device Authentication

In today's ever changing world, the Internet now follows us wherever we happen to be. Constant digital connectivity and always-on digital devices create numerous opportunities for nefarious criminals to capture, replicate and impose cloned digital credentials to effect an unauthorized (by the true owner) transfer of funds. Additional authentication checks provide the ability to leverage a mobile device itself to further increase the security model. By combining information that may be unique to the device, stored on the device, or accessed from the device along with the PII or Greenlist registry information, the user can be identified at a higher level of security for the processing of a transaction.

Transactions with Mobile Token Authentication

Digital Mobile Tokens can be created for one-time use or multi-use, and can be customized per device and per identity. Tokens can be generated locally on the device or they can be sent directly to a device by the registry. These tokens can be stored on the device itself, or accessed and stored in the cloud. Both hardware and software solutions can be used to create and manage these tokens as required for specific markets and/or applications. Tokens can be stored, maintained and resolved as linked to other unique identifiers by the registry.

Transactions with Biometric Authentication

Biometric solutions can be leveraged for identification and registration into the registry. A variety of solutions is appropriate, including, but not limited to finger print, iris, facial and voice recognition. Biometric profiles can be linked in the registry by pointers and then leveraged to provide additional levels of user identification. This can be supported either directly by mobile devices, or with the addition of accessories to expand the capabilities of the mobile device. The biometric profile information becomes an additional component of the registry data, and can be used to confirm the user at the time of a transaction.

The foregoing descriptions are meant to be illustrative and not limiting. Various changes, modifications, and additions may become apparent to the skilled artisan based upon the disclosure in this specification, and such are meant to be within the scope and spirit of the invention as defined by the appended claims.

What is claimed:

1. A method comprising:
receiving, via at least one server connected to a communication network, a rule set, wherein said rule set comprises at least one explicit permission to allow customer information to be transferred to at least one community of interest;
associating said rule set with a unique identifier, wherein said unique identifier is associated with an identifiable customer;
receiving, via said at least one server, from a requestor, a request for customer information associated with said unique identifier;
determining, via said at least one server, based on said rule set associated with said unique identifier, whether requestor has permission to receive said requested customer information; and
transferring said requested customer information to said requestor, if said requestor is determined to have permission to receive said requested customer information.

2. The method of claim 1 wherein said determination is based at least in part on which community of interest the requestor belongs to.

3. The method of claim 1 wherein said at least one explicit permission comprises the level of information that may be released and/or categories of information that may be released.

4. The method of claim 1 further comprising the step of notifying said identifiable customer when said request from requestor is received.

5. The method of claim 4 wherein said determination is based at least in part on response from said identifiable customer to said notification.

6. A computer system for use in facilitating electronic transfer of funds, comprising:
a communication link to permit the reception and transmission of communications over a network, wherein said communications relate to commercial transactions or the transfer of funds and/or assets and the proper identification of entities involved in said transfers and/or transactions;
a database organized to permit access to select account information wherein said account information includes one or more identity attributes to support a reduced risk identification of an entity involved in said transfer and said identity attributes includes transaction specific information; and
a data transmission processor for receiving requests for data associated with one or more entities and for retrieving data from said database corresponding to said request and responsive so as to support a reduced risk identification in support of a select transfer.

7. The system of claim 6 wherein said database further comprises authentication factors that permit system determination of identity with a reduction of risk of misidentification.
